(19) United States
(12) Patent Application Publication
(10) Pub. No.: US 2012/0189254 A1
(43) Pub. Date: Jul. 26, 2012

(54) ELECTRICAL-TO-OPTICAL AND OPTICAL-TO-ELECTRICAL CONVERTER PLUG

(75) Inventors: Tak Kui Wang, Cupertino, CA (US); Chung-Yi Su, Fremont, CA (US)

(73) Assignee: AVAGO TECHNOLOGIES FIBER IP (SINGAPORE) PTE. LTD., SINGAPORE (SG)

(21) Appl. No.: 13/013,928

(22) Filed: Jan. 26, 2011

(51) Int. Cl. G02B 6/36; H01R 43/00

(52) U.S. Cl. 385/93; 385/92; 29/857

(57) ABSTRACT

An electrical-to-optical and optical-to-electrical converter plug device includes a plug-shaped housing assembly, electrical contact fingers, a substantially planar circuit substrate, an optics block, and one or more opto-electronic conversion devices mounted on the circuit substrate. The opto-electronic signal conversion device has a device optical axis oriented normal to the circuit substrate and electrically coupled to the contact fingers. The optics block has a device optical port aligned with the device optical axis. The optics block has a fiber optical port oriented perpendicularly to the device optical axis. The optics block includes an optical reflector interposed in an optical path between the device optical port and the fiber optical port for redirecting an optical signal at an angle of substantially 90 degrees between a device optical port and a corresponding fiber optical port. An optical fiber can be coupled to the fiber optical port.

### BACKGROUND

In an optical data communication system, it is generally necessary to couple an optical fiber to an opto-electronic transmitter, receiver or transceiver device and, in turn, to couple the device to an electronic system such as a computer system or a switching system. These connections can be facilitated by modularizing the transceiver device. An opto-electronic transceiver module includes an opto-electronic light source, such as a laser, and an opto-electronic light receiver, such as a photodiode, and may also include various electronic circuitry associated with the laser and photodiode. For example, driver circuitry can be included for driving the laser in response to electronic signals received from the electronic system. Likewise, receiver circuitry can be included for processing the signals produced by the photodiode and providing output signals to the electronic system. The electronic and opto-electronic devices can be mounted on a small circuit board or similar substrate inside the transceiver module housing. The circuit board or associated elements can include an electrical connector for connecting the opto-electronic transceiver to the external electronic system. The opto-electronic transceiver module thus performs electrical-to-optical and optical-to-electrical signal conversion.

An optical subassembly can be included in an opto-electronic transceiver module to couple electronic signals between the optical fibers and the laser and photodiode. A first fiber, which can be referred to as a transmit fiber, is optically coupled to the laser so that optical signals generated by the transceiver module are transmitted via that transmit fiber. A second fiber, which can be referred to as a receive fiber, is optically coupled to the photodiode so that optical signals received via the receive fiber can be received by the transceiver module.

In some optical subassemblies, the optical signal path includes a 90-degree turn. For example, the above-described circuit board on which the laser and photodiode are mounted can be oriented perpendicularly or normal to the axes along which the signals are communicated with the ends of the optical fibers. The laser emits the optical transmit signal in a direction normal to the circuit board, and the photodiode receives the optical receive signal from a direction normal to the circuit board. The optical subassembly can include a first lens that collimates the optical transmit signal emitted by the laser and a second lens that focuses the optical receive signal upon the photodiode. A mirror or similar reflective element in the transceiver module can redirect the signals emitted by the laser and received by the photodiode at 90-degree angles with respect to the circuit board.

Connector systems have been suggested that include both an optical signal path and an electrical signal path. When the plug connector of such a system is plugged into the socket or receptacle connector of such a system, optical signals can be communicated in parallel with electrical signals between the plug and socket connectors. It has been suggested to provide such a connector system in a configuration similar to a Universal Serial Bus (USB) configuration.

### SUMMARY

Embodiments of the present invention relate to an electrical-to-optical and optical-to-electrical converter plug device. In an exemplary embodiment, the device includes a plug-shaped housing assembly, electrical contact fingers, a substantially planar circuit substrate, an optics block, and one or more opto-electronic conversion devices mounted on the circuit substrate. Each opto-electronic signal conversion device has a device optical axis that is oriented normal to the circuit substrate and is electrically coupled via one or more other electronic elements to at least some of the contact fingers. The optics block has a device optical port that is adjacent the opto-electronic signal conversion device and aligned with the device optical axis. The optics block also has a fiber optical port that is oriented perpendicularly to the device optical axis. The optics block further includes an optical reflector interposed in an optical path between the device optical port and the fiber optical port for redirecting an optical signal at an angle of substantially 90 degrees between a device optical port and a corresponding fiber optical port. One or more optical fibers each has an end coupled to a corresponding fiber optical port of the optics block for communicating optical signals with a corresponding opto-electronic conversion device. The optical axis of the fiber that is coupled to the fiber optical port is aligned with the fiber optical port and thus aligned with the optical reflector. Each of the one or more optical fibers extends from the optics block to the second end of the housing assembly, opposite the end at which the contact fingers are located.

Other systems, methods, features, and advantages will be or become apparent to one with skill in the art upon examination of the following figures and detailed description. It is intended that all such additional systems, methods, features, and advantages be included within this description, be within the scope of the specification, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a perspective view of a converter plug device in accordance with an exemplary embodiment of the present invention.

FIG. 2 is a block diagram of the converter plug device shown in FIG. 1.

FIG. 3 is a perspective view of the tray portion of the housing assembly of the converter plug device shown in FIG. 1.

FIG. 4 is a perspective view showing the top of an optical assembly of the converter plug device shown in FIG. 1.

FIG. 5 is similar to FIG. 4, showing the bottom of the optical assembly.

FIG. 6 is a perspective view of the optics block of the optical assembly shown in FIGS. 4-5, partially cut away along line 6-6 of FIG. 4 to show the interior.

FIG. 7 is a perspective view of the optical assembly shown in FIGS. 4-5 mounted in the tray portion shown in FIG. 2.

FIG. 8 is similar to FIG. 7, showing the bottom and rear of the assembly.

FIG. 9 is a perspective view of the opto-electronic assembly of the converter plug device shown in FIG. 1.

FIG. 10 is a perspective view showing the opto-electronic assembly of FIG. 9 being mounted in the assembly shown in FIGS. 7-8.

FIG. 11 is similar to FIG. 10, showing the opto-electronic assembly of FIG. 9 fully mounted in the assembly shown in FIGS. 7-8.

FIG. 12 is a perspective view, showing the assembly of FIG. 11 mounted within a metal shield portion of the housing assembly.

FIG. 13 is a flow diagram, illustrating an exemplary method of assembling the converter plug device of FIGS. 1-12.

### DETAILED DESCRIPTION

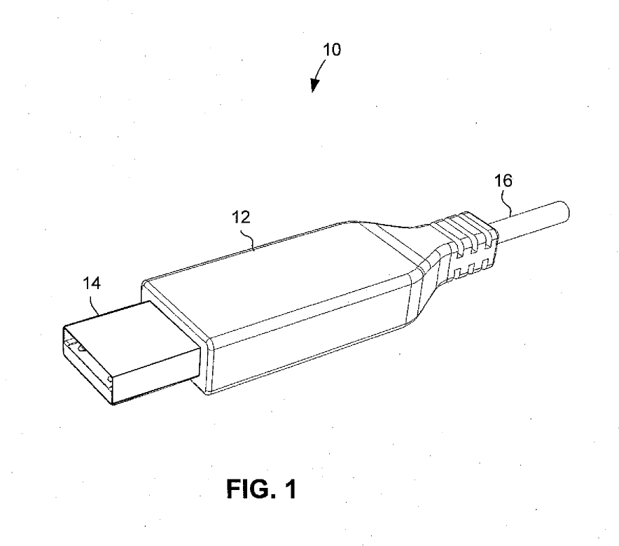

As illustrated in FIG. 1, in an illustrative or exemplary embodiment of the invention, a converter plug device 10 has an elongated, plug-like shape. An outer housing 12 made of molded plastic or similar material that is easy to grip covers the interior assemblies, which include a metal shield portion 14 extending from one end of device 10 and a cable assembly 16 extending from the opposite end of device 10.

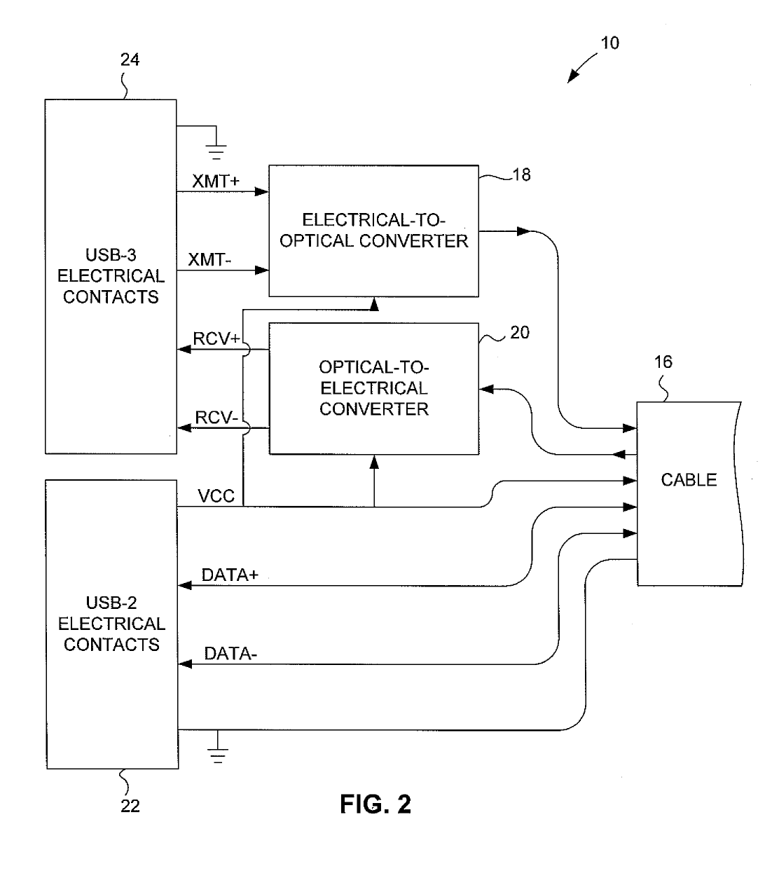

As illustrated in FIG. 2, device 10 includes an electrical-to-optical converter 18 and an optical-to-electrical converter 20. In the exemplary embodiment, device 10 is configured to be plugged into a mating socket (not shown) having a configuration that is generally in accordance with connector configurations belonging to the Universal Serial Bus (USB) family of inter-device communication specifications. Accordingly, device 10 includes two sets of electrical contacts 22 and 24 that have configurations generally in accordance with connector configurations belonging to the USB family of specifications.

One set of electrical contacts 22 can have a configuration and carry signals in accordance with the electrical contact configuration and signal pin-out plan of the USB-2 specification. As well understood in the art, the USB-2 specification specifies that the electrical contact set carry the following signals: the positive polarity side of a bidirectional differential data signal (DATA+), the negative polarity side of the bidirectional differential data signal (DATA−), a power supply voltage (VCC) and a ground potential (GND). In the exemplary embodiment, device 10 couples these USB-2 signals between the set of electrical contacts 22 and cable assembly 16. That is, USB-2 signals pass through device 10 with no effect in order to provide backward-compatibility with conventional USB-2 systems.

The other set of electrical contacts 24 can have a configuration and carry signals in accordance with the electrical contact configuration and signal pin-out plan of the USB-3 specification. As well understood in the art, the USB-3 specification specifies that the electrical contact set carry the following signals: the positive polarity side of a differential data transmit signal (XMT+), the negative polarity side of the differential data transmit signal (XMT−), the positive polarity side of a differential data receive signal (RCV+), and the negative polarity side of the differential data receive signal (RCV+). The differential transmit signal (XMT) carried on a contact pair in the set of electrical contacts 24 is input to electrical-to-optical converter 18, which converts the differential transmit signal to an optical signal form and outputs the resulting optical data transmit signal via cable assembly 16. An optical-to-electrical converter 20 receives an optical receive signal via cable assembly 16, converts the optical data receive signal to an electrical signal form, and outputs the resulting differential data receive signal (RCV) via another contact pair in the set of electrical contacts 24. Thus, device 10 converts USB-3 optical signals received via cable assembly 16 to electrical signals that it outputs via the set of electrical contacts 24, and converts USB-3 electrical signals received via the set of electrical contacts 24 to optical signals that it outputs via cable assembly 16.

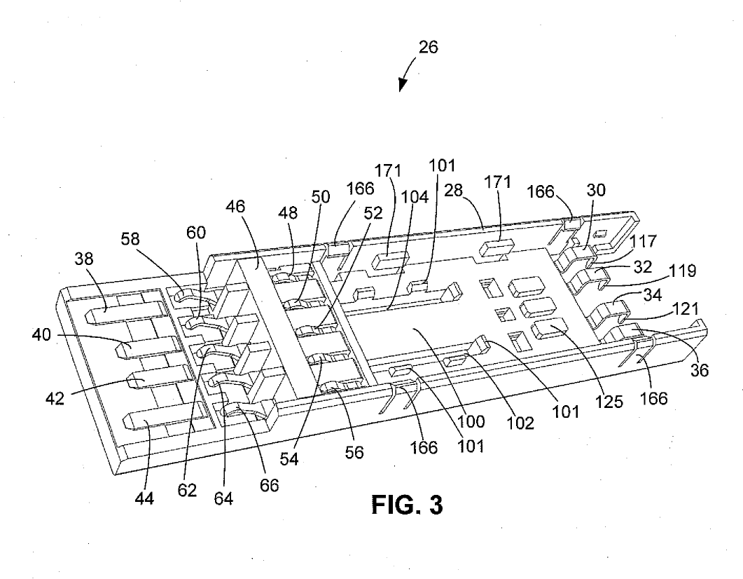

As illustrated in FIG. 3, a tray assembly 26 in device 10 includes a tray 28. Four conductors 30, 32, 34 and 36 are retained within tray 28 and span the length of tray 28 from the front of device 10 to the rear of device 10. For reference purposes the term “front” is used herein to refer to that portion of device 10 that plugs into a socket (not shown), and the term “rear” is used herein to refer to that portion of device 10 from which cable assembly 16 extends. The front portions of conductors 30, 32, 34 and 36 define electrical contact fingers 38, 40, 42 and 44, respectively. Conductors 30-36 and their associated electrical contact fingers 38-44 carry the above-referenced USB-2 signals. In other words, electrical contact fingers 38-44 belong to the above-referenced set of electrical contacts 22 (FIG. 2). A front electrical contact block 46 is mounted in tray 28 and retains five other conductors 48, 50, 52, 54 and 56. The front portions of conductors 48, 50, 52, 54 and 56 define electrical contact fingers 58, 60, 62, 64 and 66, respectively. Conductors 48-56 and their associated electrical contact fingers 58-66 carry the above-referenced USB-3 signals. In other words, electrical contact fingers 58-66 belong to the above-referenced set of electrical contacts 24 (FIG. 2). It should be noted that the elongated, blade-like shapes of electrical contact fingers 38-44 defining the set of electrical contacts 22 and their arrangement in a side-by-side or parallel array with one another, is characteristic of a USB connector. Likewise, the elongated, blade-like shapes of electrical contact fingers 58-66 defining the set of electrical contacts 24 and their arrangement in a side-by-side or parallel array with one another, is characteristic of a USB connector. It can also be noted that electrical contact fingers 38-44 substantially are arrayed within a plane that is parallel to (but offset from, i.e., not coplanar with) a plane in which electrical contact fingers 58-66 substantially are arrayed.

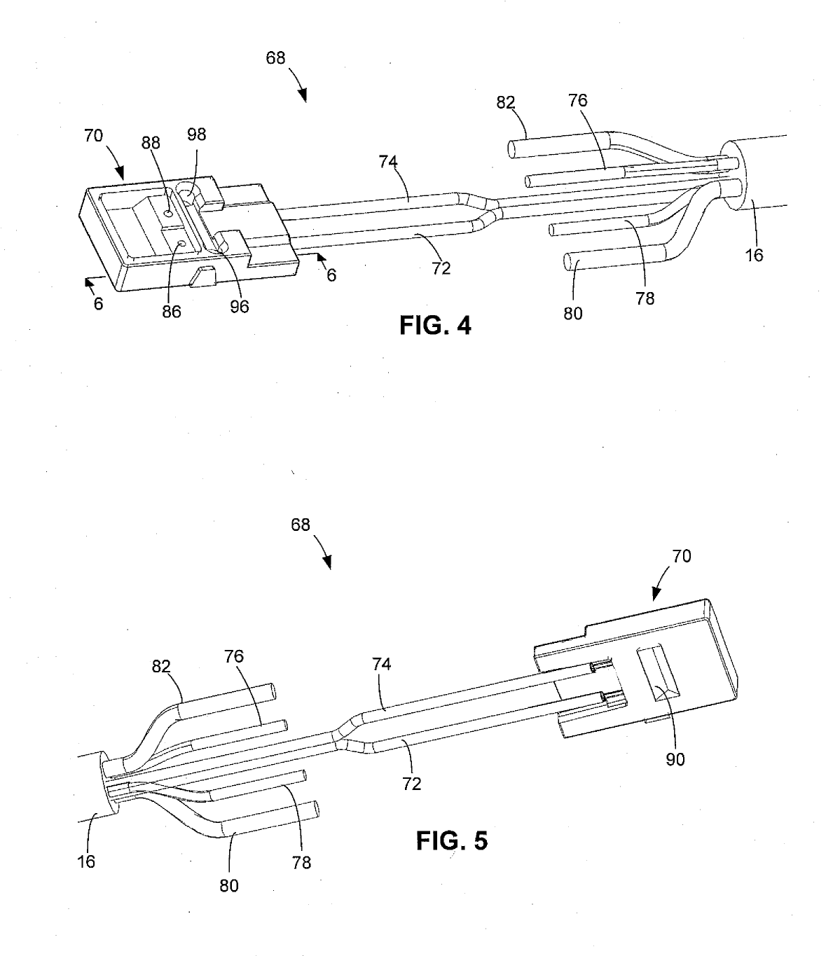

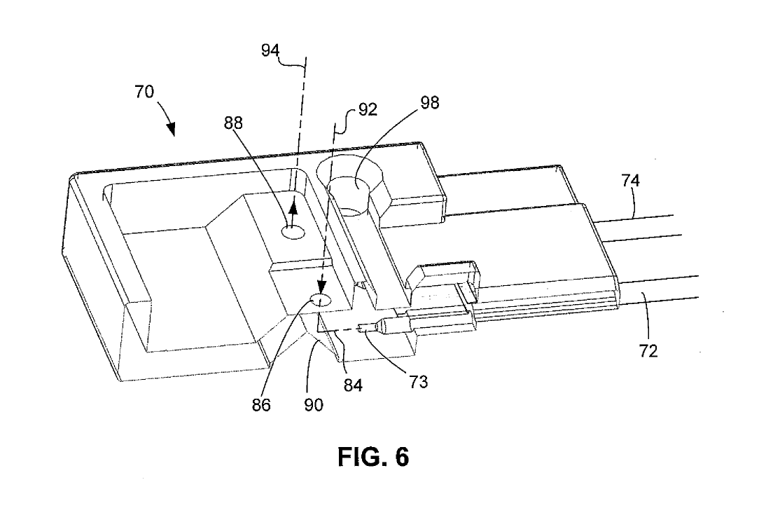

As illustrated in FIGS. 4-6, an optical assembly 68 includes an optics block 70 and the above-referenced cable assembly 16. Optics block 70 can be made of a single or unitary piece of molded plastic material that is of optical quality and transparent to the wavelengths of light at which the optical signals described herein are transmitted and received. (In the drawing figures, optics block 70 is depicted as transparent to visible light for purposes of illustration.) Cable assembly 16 includes a transmit optical fiber 72, a receive optical fiber 74, a positive-polarity data wire 76 (carrying the above-described DATA+ signal), a negative-polarity data wire 78 (carrying the above-described DATA− signal), a power supply voltage (VCC) wire 80, and a ground (GND) wire 82. An end of transmit optical fiber 72 is received (FIGS. 5-6) in a bore in optics block 70 that defines a transmit fiber optical port. Likewise, an end of receive optical fiber 74 is received in another bore in optics block 70 that defines a receive fiber optical port. The exterior sheaths of transmit optical fiber 72 and receive optical fiber 74 can be stripped between their extreme ends 73 and the points at which they enter the bores. The cladding at the extreme ends 73 of optical fibers 72 and 74 can also be stripped so as to expose the fiber cores, which are received within smaller-diameter bores at the bottoms of the larger bores. A transparent optical adhesive can be used to secure transmit and receive optical fibers 72 and 74 to optics block 70. As illustrated in FIG. 6, the extreme end 73 of transmit optical fiber 72 has a transmit fiber axis 84 that is aligned with the transmit fiber optical port. Although not shown for purposes of clarity, the extreme end of receive optical fiber 74 similarly has a receive fiber axis that is aligned with the receive fiber optical port.

As shown in FIG. 6, optics block 70 has a transmit device optical port 86 and a receive device optical port 88. Optics block 70 also includes an optical reflector 90 interposed in an optical signal path between the above-referenced fiber optical ports and device optical ports 86 and 88. In the exemplary embodiment, optical reflector 90 has a reflective surface oriented at an angle of 45 degrees with respect to all of the optical ports. Transmit device optical port 86 is aligned with a transmit optical port axis 92, and the transmit fiber optical port is aligned with transmit fiber axis 84, which is perpendicular to transmit optical port axis 92. Thus, optical signals that enter optics block 70 through transmit device optical port 86 are reflected by optical reflector 90 at a 90-degree angle into the end of transmit optical fiber 72 (along transmit fiber axis 84) in the transmit fiber optical port. Note that, for example, transmit optical port axis 92 and transmit fiber axis 84 define one of the optical signal paths in which optical reflector 90 is interposed. A similar optical signal path between receive device optical port 88 and the receive fiber optical port is not shown for purposes of clarity but defines another such optical path. In this other optical signal path, receive device optical port 88 is aligned with a receive optical port axis 94. Although not shown for purposes of clarity, transmit and receive device optical ports 86 and 88 can include a collimating lens and a focusing lens, respectively. Alternatively or in addition, a collimating lens and a focusing lens can be formed directly on the reflective surface of optical reflector 90.

A feature of optics block 70 that is described below in further detail involves two cylindrical bores 96 and 98 (FIGS. 4 and 6) in the upper surface of optics block 70, i.e., the surface through which the above-referenced optical signals are transmitted and received.

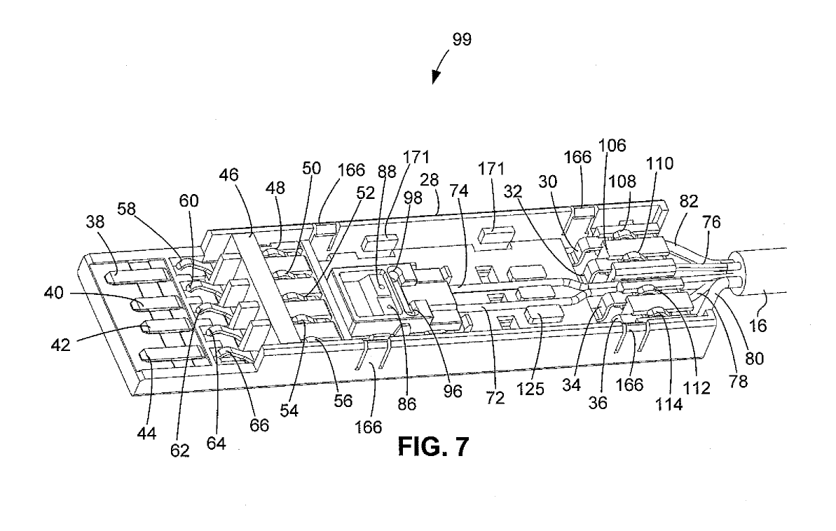

As illustrated in FIG. 7, optical assembly 68 (FIGS. 4-5) is mounted in tray 28 of tray assembly 26 (FIG. 3) to define another assembly 99. Mounted in the manner shown, optics block 70 rests on a strip 100 (FIG. 3) in the middle of tray 28 that is defined by a region of tray 28 between two slots 102 and 104 (FIG. 3). Several features or nubs 101 that project slightly above the bottom of tray 28 around the edges of strip 100 help guide optics block 70 roughly into position but leave some amount of play or tolerance so that optics block 70 can be more precisely guided into an aligned position, in accordance with a fine-alignment feature of this embodiment that is described below. As described below in further detail with regard to another feature of this embodiment, slots 102 and 104 allow strip 100 to flex or bend very slightly.

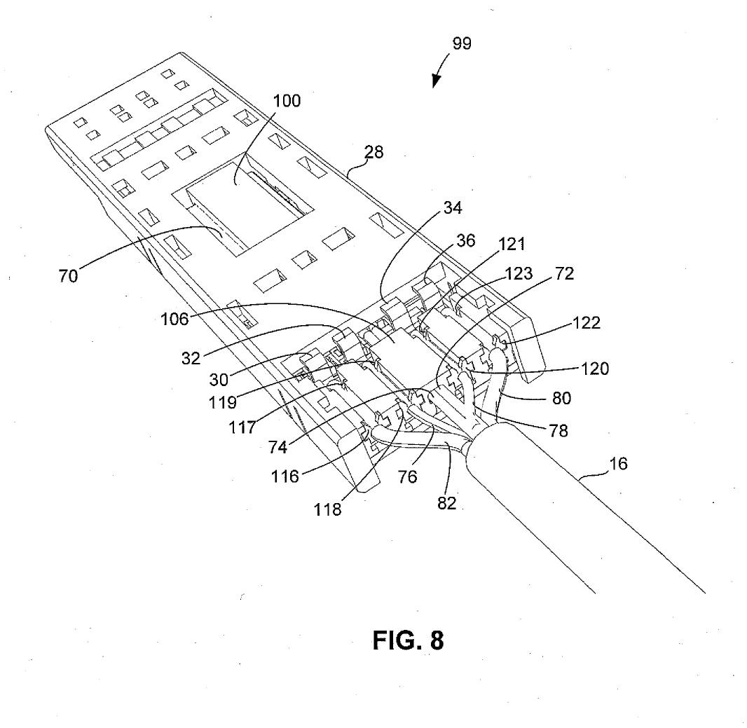

A rear electrical contact block 106 is mounted at the rear of tray 28. Electrical contact block 106 retains four conductors 108, 110, 112 and 114 that include insulation displacement connectors 116, 118, 120 and 122, respectively, as shown in FIG. 8. Insulation displacement connectors 116, 118, 120 and 122 have generally V-shaped slots that receive or engage wires 82, 76, 78 and 80, respectively. The knife-like edges of the V-shaped slots slice through the insulation in wires 82, 76, 78 and 80 and make electrical contact with the metal wire cores as wires 82, 76, 78 and 80 are pressed into the V-shaped slots. Similarly, the ends of conductors 30, 32, 34 and 36 are retained in electrical contact block 106 and include four other insulation displacement connectors 117, 119, 121 and 123, respectively. These other insulation displacement connectors 117, 119, 121 and 123 similarly slice through the insulation in wires 82, 76, 78 and 80 and make electrical contact with the metal wire cores as wires 82, 76, 78 and 80 are pressed into the V-shaped slots. Thus, both the set of insulation displacement connectors 116, 118, 120 and 122 and the set of insulation displacement connectors, 117, 119, 121 and 123 make contact with the same set of wires 82, 76, 78 and 80.

The insulation displacement connector 119 that engages positive-polarity data (DATA+) wire 76 is part of conductor 32 and is thus coupled to electrical contact finger 40. The insulation displacement connector 121 that engages negative-polarity data (DATA−) wire 78 is part of conductor 34 and is thus coupled to electrical contact finger 42. The insulation displacement connector 123 that engages power supply voltage (VCC) wire 80 is part of conductor 36 and is thus coupled to electrical contact finger 44. The insulation displacement connector 117 that engages ground (GND) wire 82 is part of conductor 30 and is thus coupled to electrical contact finger 38. Insulation displacement connector 122, which also engages power supply voltage wire 80, is part of conductor 114, which provides power to electronic elements as described below. Likewise, insulation displacement connector 116, which also engages ground wire 82, is part of conductor 108, which provides the ground potential to the electronic elements.

As shown in FIGS. 7-8, transmit optical fiber 72 and receive optical fiber 74 extend through tray 28 between optics block 70 and the rear of tray 28, where they exit tray 28 and become part of cable assembly 16. A number of guides 125 help maintain a spacing between optical fibers 72 and 74 that matches the spacing between the transmit fiber optical port and receive fiber optical port of block 70.

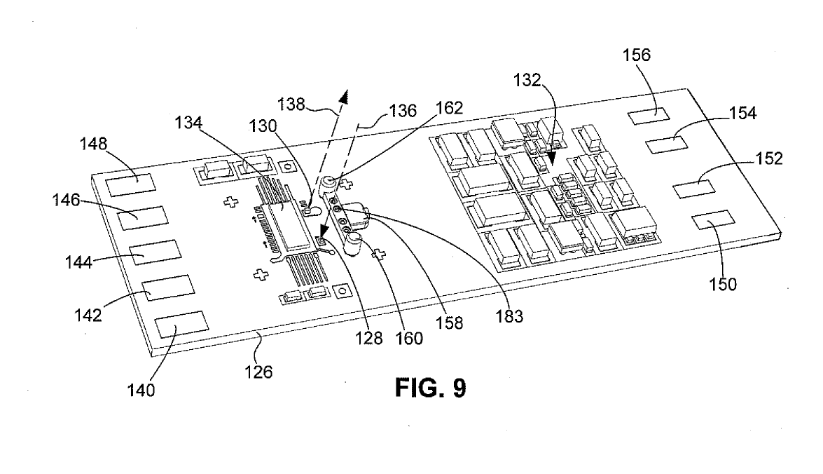

As illustrated in FIG. 9, an opto-electronic assembly 124 includes a printed circuit board 126 having various electronic devices mounted on its top surface. The electronic devices include an opto-electronic light source 130, such as a laser, and an opto-electronic light receiver 128, such as a photodiode. Other electronic devices can include, for example, power regulator circuitry 132 and a signal processing integrated circuit 134 that includes driver circuitry for driving opto-electronic light source 130 with electrical signals and receiver circuitry for processing electrical signals received from opto-electronic light receiver 128. That is, opto-electronic light source 130 converts electrical signals into optical signals, and opto-electronic light receiver 128 converts optical signals into electrical signals. Opto-electronic light source 130 is mounted on printed circuit board 126 in an orientation in which it can emit optical signals along a transmit device optical axis 138. Opto-electronic light receiver 128 is mounted on printed circuit board 126 in an orientation in which it can receive optical signals along a receive device optical axis 136.

Printed circuit board 126 includes circuit traces, vias or other electrical signal conductors, which are not shown for purposes of clarity but which interconnect the various electronic devices described above. Such interconnections can be in accordance with the above-described block diagram of FIG. 2, where opto-electronic light source 130 and it associated driver circuitry define electrical-to-optical converter 18, and opto-electronic light receiver 128 and its associated receiver circuitry define optical-to-electrical converter 20. The conductors of printed circuit board 126 also include five electrical contact pads 140, 142, 144, 146 and 148 at the front of printed circuit board 126 and four electrical contact pads 150, 152, 154 and 156 at the rear of printed circuit board 126. The five electrical contact pads 140-148 carry the above-referenced USB-3 signals, and the four electrical contact pads 150-156 carry the above-referenced USB-2 signals.

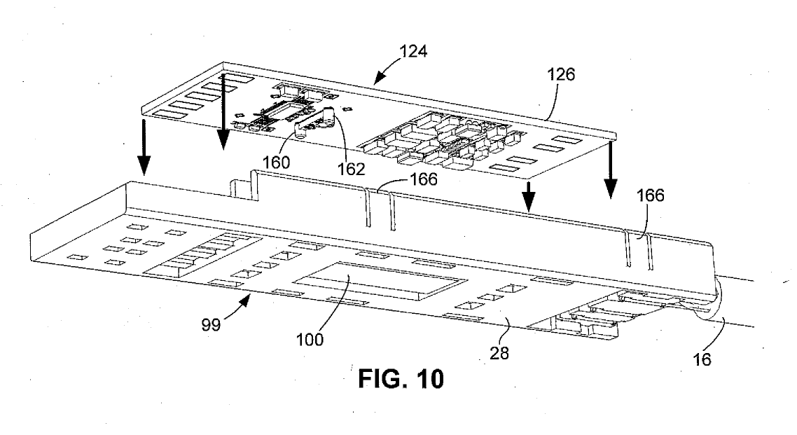

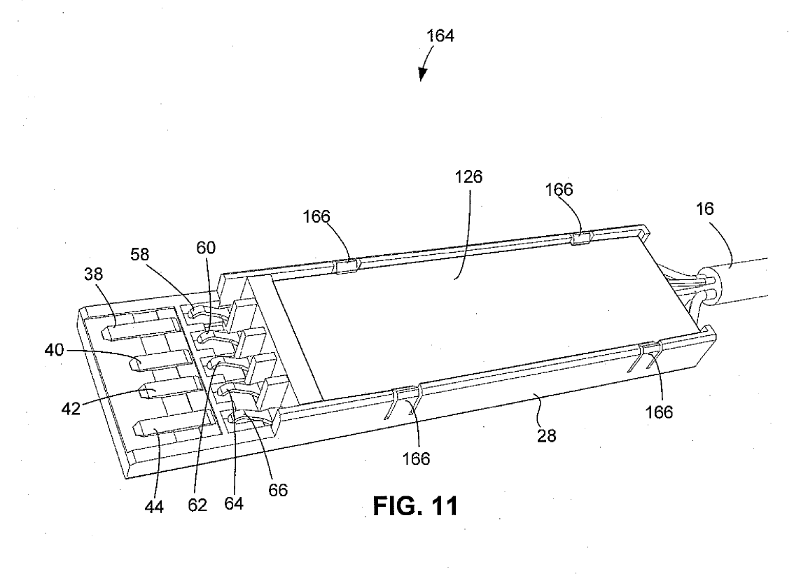

An alignment device referred to herein as a “key” 158 or portion of an alignment key is mounted on printed circuit board 126. As described below in further detail with regard to an exemplary assembly method, key 158 can be used for aiding precise placement of opto-electronic light source 130 and opto-electronic light receiver 128 and for aiding alignment of them with other elements. Key 158 includes two post-like protuberances 160 and 162 that extend in a direction away from, i.e., normal to, the top surface of printed circuit board 126. As illustrated in FIG. 10, when opto-electronic assembly 124 and assembly 99 (FIG. 7) are assembled together to form the complete assembly 164 shown in FIG. 11, post-like protuberances 160 and 162 of key 158 are received in the above-referenced corresponding cylindrical bores 96 and 98 in the upper surface of optics block 70. Protuberances 160 and 162 have chamfered ends, and cylindrical bores 96 and 98 have chamfered openings that together help guide post-like protuberances 160 and 162 into cylindrical bores 96 and 98. Although in the exemplary embodiment these elements have chamfers to help guide and align them with each other, in other embodiments such elements can have any other suitable tapers or contours that provide similar guiding and aligning effects.

Assembling opto-electronic assembly 124 and assembly 99 in the above-described manner helps guide transmit device optical port 86 of optics block 70 into alignment with transmit device optical axis 138 and guide receive device optical port 88 into alignment with receive device optical axis 136. Thus, in the exemplary embodiment post-like protuberances 160 and 162 of key 158 on opto-electronic assembly 124 serve as an alignment key first portion, and cylindrical bores 96 and 98 in optics block 70 of optical assembly 68 serve as a an alignment key second portion. Nevertheless, an opto-electronic assembly in accordance with other embodiments can include any other suitable type of recess or other alignment key first portion, and an optical assembly in accordance with such other embodiments can include any other suitable type of protuberance or other alignment key second portion that can engage the recess or other alignment key first portion. Also, although in the exemplary embodiment opto-electronic assembly 124 has post-like protuberances 160 and 162 of key 158, and optical assembly 68 has cylindrical bores 96 and 98, in other embodiments an opto-electronic assembly or similar element can have one or more bores or other recesses while an optical assembly or similar element can have one or more protuberances or other projecting or mating portions that can engage the recesses.

In assembling opto-electronic assembly 124 and assembly 99 into complete assembly 164 (FIG. 11) in the above-described manner, four engagement hooks 166 along the sides of tray 28 snap over printed circuit board 126 as printed circuit board 126 is pressed into tray 28 and thus retain printed circuit board 126 in tray 28.

In complete assembly 164 (FIG. 11), electrical contact pads 140, 142, 144, 146 and 148 of printed circuit board 126 (FIG. 9) contact electrical contact fingers 58, 60, 62, 64 and 66 (FIGS. 3 and 7), respectively. Similarly, electrical contact pads 150, 152, 154 and 156 of printed circuit board 126 contact electrical contact fingers 108, 110, 112 and 114, respectively. Note that the contact between electrical contact finger 114 and electrical contact pad 156 provides the power supply voltage (VCC) to electronic devices on printed circuit board 126. Likewise, the contact between electrical contact finger 108 and electrical contact pad 150 provides the ground potential (GND) to electronic devices on printed circuit board 126.

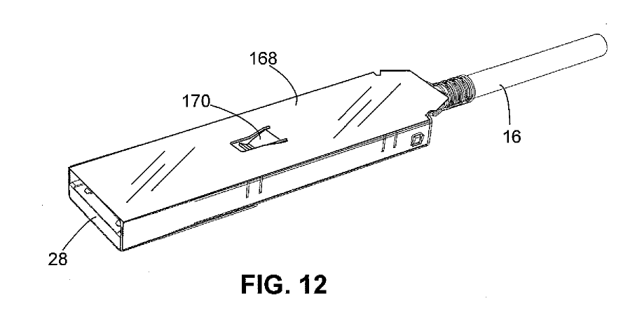

As illustrated in FIG. 12, a metal shielding enclosure 168 can be attached around complete assembly 164 (not visible in FIG. 12). Shielding enclosure 168 can include a resilient tab 170 that exerts a force upon the bottom surface of printed circuit board 126. The force exerted by resilient tab 170 against printed circuit board 126 presses printed circuit board 126 toward optics block 70 and thus maintains post-like protuberances 160 and 162 of key 158 securely within cylindrical bores 96 and 98 in optics block 70, thereby inhibiting relative motion between optics block 70 and the opto-electronic signal conversion devices (i.e., opto-electronic light source 130 and opto-electronic light receiver 128). Four stops 171 positioned on the walls of tray 28 act as stops to prevent printed circuit board 126 from flexing excessively in response to the force exerted by resilient tab 170. Also, as described above with regard to FIGS. 3 and 7, optics block 70 rests against strip 100, which is also somewhat resilient and can bow slightly outwardly (e.g., on the order of tens of microns) in response to the force exerted by resilient tab 170. Thus, the forces exerted by resilient tab 170 and the bowed strip 100 from opposite directions help to inhibit movement between optics block 70 and opto-electronic assembly 124. This maintains opto-electronic light source 130 in optical alignment with device optical port 86 and maintains opto-electronic light receiver 128 in optical alignment with device optical port 88.

Outer housing 12 (FIG. 1) can be formed over shielding enclosure 168 to complete the assembly of converter plug device 10. Although in the exemplary embodiment converter plug device 10 has a plug-shaped housing assembly that includes outer housing 12, shielding enclosure 168, and other elements such as tray 28, in other embodiments a converter plug device can have a plug-shaped housing assembly that includes any other suitable combination of one or more elements.

Although converter plug device 10 is described above with regard to an exemplary embodiment of the invention having the above-described elements, it should be understood that in other embodiments a device in accordance with the present invention can include more elements, fewer elements or different elements. For example, a group of two or more of the above-described elements of converter plug device 10 can correspond to a single element in another embodiment of such a device or, conversely, an element of converter plug device 10 that is described above as being a unitary or discrete element can correspond to a group of two or more elements in another embodiment of such a device.

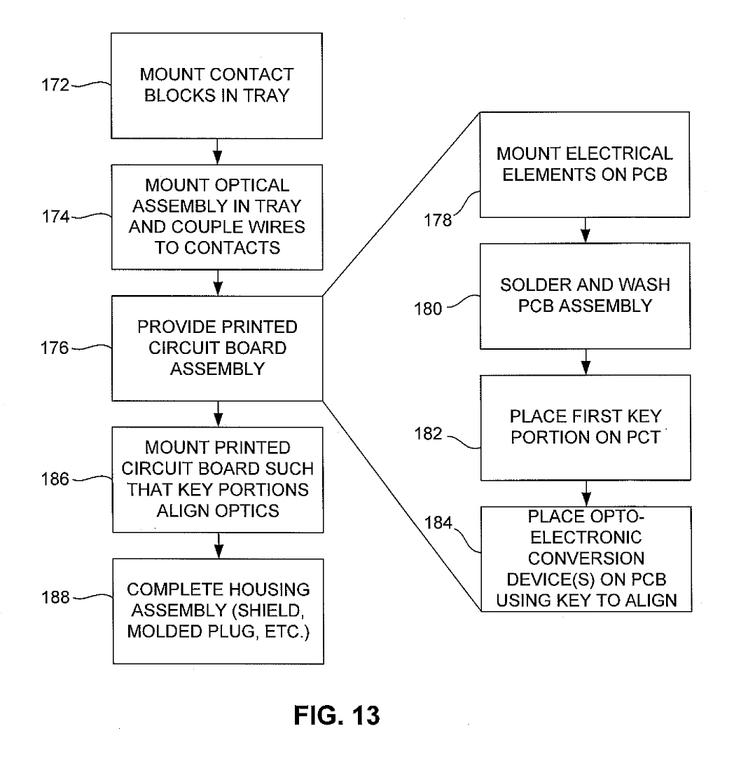

As illustrated by the flow diagram of FIG. 13, an exemplary method for making a device such as the above-described converter plug device 10 can be described as follows. As indicated by block 172, contact blocks 46 and 106 can be mounted in tray 28 and such base portions of the housing assembly otherwise provided. Conductors having electrical contact fingers can be included in (e.g., by insert molding) or attached to one or more such portions of the housing assembly. As indicated by block 174, optical assembly 68 can be mounted in tray 28 and its wires 76-82 coupled to contact block 106 by pressing them into insulation displacement connectors 116-123. As indicated by block 176, opto-electronic assembly 124, comprising printed circuit board 126 and the electronic devices mounted thereon, can be provided.

As indicated by block 178, in the exemplary method, opto-electronic assembly 124 (FIG. 9) can be provided by mounting electronic devices on printed circuit board 126 that include the driver and receiver circuitry associated with opto-electronic light source 130 and opto-electronic light receiver 128 and other circuitry but not including opto-electronic light source 130 and opto-electronic light receiver 128 themselves. As indicated by block 180, mounting the electronic devices on printed circuit board 126 can include conventional processes such as soldering and washing off excess solder flux. As indicated by block 182, key 158 can be mounted on printed circuit board 126 after such processes so that key 158 and other elements that can affect alignment among the optical and opto-electronic elements are not subjected to the heat or other harsh effects associated with such processes that could otherwise adversely affect their optical alignment. (Also note that, as indicated by above-described block 174, optics block 70 is similarly not subjected to such processes, as wires 76-82 are pressed into insulation displacement connectors 116-123 rather than soldered.) Thus, after such processes, and after key 158 is mounted on printed circuit board 126, opto-electronic light source 130 and opto-electronic light receiver 128 can be mounted on printed circuit board 126 by using fiducial markings 183 (FIG. 9) on key 158 as spatial reference points to guide a conventional robotic machine-vision pick-and-place machine or a wirebonding machine, as indicated by block 184. As well understood in the art, such machines can use pattern recognition and similar “machine-vision” techniques to guide its robotics in precisely placing devices on a printed circuit board and wirebonding them. Opto-electronic light source 130 and opto-electronic light receiver 128 can be wirebonded to signal processing integrated circuit 134.

As indicated by block 186, after opto-electronic assembly 124 (FIG. 9) is provided in the manner described above, it can be mounted on assembly 99 (FIG. 7) to form complete assembly 164 (FIG. 11). As described above, in mounting opto-electronic assembly 124 onto assembly 99, post-like protuberances 160 and 162 of key 158, which define an alignment key first portion, are received in corresponding cylindrical bores 96 and 98 in the upper surface of optics block 70, which define an alignment key second portion. This engagement between the alignment key first and second portions helps guide transmit device optical port 86 of optics block 70 into alignment with transmit device optical axis 138 and guide receive device optical port 88 into alignment with receive device optical axis 136, as described above. As indicated by block 188, the housing assembly of converter plug device 10 can then be completed by, for example, adding other elements of the housing assembly, such as shielding enclosure 168, outer housing 12, etc. Optical alignment between the above-described elements opto-electronic assembly 124 and assembly 99 is not disturbed because no soldering, washing or other process steps of the type described above are performed after opto-electronic assembly 124 and assembly 99 are assembled.

It should be noted that although some process steps are described above as occurring after others in the exemplary embodiment, in other embodiments process steps can occur in any other suitable order. Also, additional process steps or sub-steps that are not described above can be included, as understood by persons skilled in the art.

One or more illustrative or exemplary embodiments of the invention have been described above. However, it is to be understood that the invention is defined by the appended claims and is not limited to the specific embodiments described.

What is claimed is:

1. A device, comprising:
a plug-shaped housing assembly having an elongated shape extending between a first end and a second end;
a plurality of electrical conductors defining electrical contact fingers mounted in the housing assembly at the first end of the housing assembly;
a substantially planar circuit substrate mounted in the housing assembly;
a plurality of electronic devices mounted on the substantially planar circuit substrate, the plurality of electronic devices including at least one opto-electronic signal conversion device having a device optical axis normal to the substantially planar circuit substrate, the at least one opto-electronic signal conversion device electrically coupled to at least some of the plurality of electrical contact fingers;
an optics block mounted in the housing assembly, the optics block having a device optical port adjacent the at least one opto-electronic signal conversion device and aligned with the device optical axis, a fiber optical port oriented perpendicularly to the device optical axis, and an optical reflector interposed in an optical path between the device optical port and the fiber optical port for redirecting an optical signal at an angle of substantially 90 degrees between the device optical port and the fiber optical port; and
at least one optical fiber having an end coupled to the fiber optical port of the optics block, the end coupled to the fiber optical port having a fiber axis aligned with the fiber optical port, the at least one optical fiber extending between the optics block and the second end of the housing assembly.

2. The device claimed in claim 1, further comprising a first key portion mounted on the substantially planar circuit substrate, wherein the optics block has a second key portion engaging the first key portion.

3. The device claimed in claim 2, wherein the housing assembly has a resilient portion, the resilient portion exerting an engagement force between the first key portion and the second key portion.

4. The device claimed in claim 2, wherein one of the first key portion and the second key portion comprises a protuberance, and the other of the first key portion and the second key portion comprises a recess.

5. The device claimed in claim 4, wherein the protuberance comprises a post having a chamfered distal end, the recess comprises a cylindrical cavity in the optics block having a chamfered opening, the post has a diameter substantially equal to a diameter of the cylindrical cavity, and the chamfered distal end of the post engages the chamfered opening of the cylindrical cavity to align the device optical port of the optics block with the device optical axis of the at least one opto-electronic device.

6. The device claimed in claim 1, wherein:
the optics block comprises a unitary piece of molded optical material transparent to light associated with the at least one opto-electronic signal conversion device; and
the optical reflector comprises a total internal reflection lens formed in the molded optical material.

7. The device claimed in claim 1, wherein the substantially planar circuit substrate includes a plurality of electrical contact pads, the plurality of electrical contact pads in contact with portions of the plurality of electrical conductors to electrically couple the at least one opto-electronic signal conversion device to the at least some of the plurality of electrical contact fingers.

8. The device claimed in claim 1, wherein the plurality of electronic devices includes at least signal processing device coupled to the at least one opto-electronic signal conversion device and at least some of the plurality of electrical contact fingers, the at least one signal processing device receiving electrical power via the plurality of electrical contact fingers.

9. The device claimed in claim 1, wherein:
the plurality of electrical contact fingers includes a first plurality of electrical contact fingers oriented arrayed in parallel with one another in a first substantially planar array and a second plurality of electrical contact fingers oriented arrayed in parallel with one another in a second substantially planar array, the second substantially planar array non-coplanar with the first substantially planar array; and
the first plurality of electrical contact fingers is coupled to the at least one opto-electronic signal conversion device; and
the second plurality of electrical contact fingers is electrically coupled to a corresponding plurality of electrical wires extending out of the second end of the housing assembly in a cable bundle including the at least one optical fiber.

10. The device claimed in claim 9, wherein at least some of the plurality of electrical contact fingers are arranged in a Universal Serial Bus configuration.

11. The device claimed in claim 9, wherein the second plurality of electrical contact fingers is coupled to a corresponding plurality of electrical wires by the plurality of electrical wires being engaged in an insulation displacement connector electrically coupled to the plurality of electrical conductors.

12. The device claimed in claim 9, wherein:
the at least one opto-electronic device comprises an opto-electronic light source and an opto-electronic light receiver;
the at least one optical fiber comprises a transmit optical fiber and a receive optical fiber;
the opto-electronic light source is coupled to the transmit optical fiber;
the opto-electronic light receiver is coupled to the receive optical fiber; and
the second plurality of electrical contact fingers is electrically coupled to a corresponding plurality of electrical wires extending out of the second end of the housing assembly in a cable bundle including the transmit optical fiber and the receive optical fiber.

13. A method for making a device, comprising:
providing a plug-shaped housing assembly having an elongated shape extending between a first end and a second end;
providing a plurality of electrical conductors in the housing assembly, the plurality of electrical conductors defining electrical contact fingers at the first end of the housing assembly;
mounting an optical assembly in a portion of the housing assembly, the optical assembly having an optics block and at least one optical fiber, the optics block having a device optical port, a fiber optical port, and an optical reflector interposed in an optical path between the device optical port and the fiber optical port for redirecting an optical signal at an angle of substantially 90 degrees between the device optical port and the fiber optical port, the at least one optical fiber having an end coupled to the fiber optical port of the optics block, the end coupled to the fiber optical port having a fiber axis aligned with the fiber optical port, the at least one optical fiber extending between the optics block and the second end of the housing assembly; and
mounting an opto-electronic assembly in the housing assembly, the opto-electronic assembly comprising a substantially planar circuit substrate and a plurality of electronic devices mounted on the substantially planar circuit substrate, the plurality of electronic devices including at least one opto-electronic signal conversion device having a device optical axis normal to the substantially planar circuit substrate, the at least one opto-electronic signal conversion device electrically coupled to at least some of the plurality of electrical contact fingers, the device optical axis aligned with the device optical port of the optics block.

14. The method claimed in claim 13, wherein mounting an opto-electronic assembly in the housing assembly comprises a first key portion of the substantially planar circuit substrate engaging a second key portion on the optics block to guide the device optical port of the optics block into alignment with the device optical axis of the at least one opto-electronic device.

15. The method claimed in claim 14, wherein mounting an opto-electronic assembly in the housing assembly comprises a protuberance defining one of the first key portion and the second key portion extending into a recess in the other of the first key portion and the second key portion, the protuberance having a chamfered distal end and the recess having a chamfered opening receiving the protuberance, to guide the device optical port of the optics block into alignment with the device optical axis of the at least one opto-electronic device.

16. The method claimed in claim 13, wherein mounting an optical assembly in the housing assembly comprises:
attaching the plurality of electronic devices to the substantially planar circuit substrate by placing the plurality of electronic devices on the substantially planar circuit substrate and subjecting the substantially planar circuit substrate and plurality of electronic devices to at least one high-temperature process;
after subjecting the substantially planar circuit substrate and plurality of electronic devices to at least one high-temperature process, mounting a first key portion on the substantially planar circuit substrate; and
after mounting the first key portion on the substantially planar circuit substrate, mounting the at least one opto-electronic conversion device on the substantially planar circuit substrate.

17. The method claimed in claim 16, wherein mounting the at least one opto-electronic conversion device on the substantially planar circuit substrate comprises a robotic machine-vision pick-and-place machine being guided by a plurality of fiducial markings on the first key portion in placing the at least one opto-electronic conversion device on the substantially planar circuit substrate.

18. The method claimed in claim 17, wherein mounting an opto-electronic assembly in the housing assembly comprises a first key portion of the substantially planar circuit substrate engaging a second key portion on the optics block to guide the device optical port of the optics block into alignment with the device optical axis of the at least one opto-electronic device after mounting the at least one opto-electronic conversion device on the substantially planar circuit substrate.

19. The method claimed in claim 17, wherein mounting an opto-electronic assembly in the housing assembly comprises a portion of the housing assembly exerting an engagement force between the first key portion and the second key portion to inhibit movement between the optics block and the at least one opto-electronic device.
